(19) United States
(12) Patent Application Publication
(10) Pub. No.: US 2008/0048531 A1
(43) Pub. Date: Feb. 28, 2008

(54) GENERATOR FOR A BICYCLE

(75) Inventor: Wang Cheung CHAN, Hong Kong (HK)

Correspondence Address: HESLIN ROTHENBERG FARLEY & MESITI PC, 5 COLUMBIA CIRCLE, ALBANY, NY, 12203, US

(73) Assignee: PANTENE INDUSTRIAL CO., LTD., Hong Kong (HK)

(21) Appl. No.: 11/466,883

(22) Filed: Aug. 24, 2006

(51) Int. Cl. H02K 7/00

(52) U.S. Cl. 310/67 R; 310/259

(57) ABSTRACT

An electric generator for a bicycle comprising, a rotor assembly comprising a plurality of magnets disposed at regular spacings around the circumference of the rotor assembly in alternating polarity, a stator core, comprising steel plates being stacked to form the stator core, each steel plate having a U-shaped grooved cross-section with two oppositely extending magnetically engaging members, a power-generating coil is wound around the U-shaped groove of the steel plates of the stator core, and the magnetically engaging members are positioned to magnetically engage the magnets of the rotor assembly.

### FIELD OF THE INVENTION

The present invention relates to a generator for a bicycle, and in particular to a stator and rotor of a generator for a bicycle.

### BACKGROUND OF THE INVENTION

Electrical generators for bicycles are well known and popular especially given the wide variety of electrical accessories for bicycles currently available on the market which require onboard electricity to power them. The electrical generators or dynamos provide a self-sufficiency which is valued by their users: no batteries to recharge or replace, and can be permanently fitted to the bicycle.

There are four main types of electrical generators for bicycles: hub generators which are built into the front hub, and are generally the most efficient but also the most expensive and requires the replacement of the hub; bottle generators which attach to a fork leg and are rotated by a small wheel in contact with the tyre sidewall, they are generally easiest to obtain and cheapest; bottom bracket generators which bolt between the chain stays behind the bottom bracket and are powered by a roller against the tyre, these are easy to fit and do not wear the tyre sidewall; and rotor generators which has a rotor mounted to the wheel and a stator mounted on the fork, they are generally cheap and efficient and provide a good alternative to hub generators.

The present invention relates to a new type of rotor generator which addresses some of the drawbacks of earlier designs, such as efficiency of the stator, and difficulties in mounting and centering the rotor on the wheel. Thus, there is a need for a more cost effective, easy to install, and more efficient type of rotor generator for a bicycle.

### SUMMARY OF THE INVENTION

The present invention is directed to an electric generator for a bicycle comprising, a rotor assembly comprising a plurality of magnets disposed at regular spacings around the circumference of the rotor assembly in alternating polarity, a stator core, comprising steel plates stacked to form the stator core, each steel plate having a U-shaped grooved cross-section with two oppositely extending magnetically engaging members, a power-generating coil wound around the U-shaped groove of the steel plates of the stator core and the magnetically engaging members being positioned to magnetically engage the magnets of the rotor assembly.

In another aspect, the present invention is directed to an electric generator for a bicycle comprising a rotor assembly comprising a plurality of magnets disposed at regular spacings around the circumference of the rotor assembly in alternating polarity an annular stator core, having a radially outer facing U-shaped annular groove and having a power-generating coil wound around the U-shaped groove a first annular ring disposed on a side of the annular stator core, with a plurality of radially extending magnetically engaging members being positioned to magnetically engage the magnets of the rotor assembly and a second annular ring disposed on another side of the annular stator core, with radially extending magnetically engaging members being positioned to magnetically engage the magnets of the rotor assembly.

An additional aspect of this invention is directed to a rotor assembly for a bicycle generator for mounting on to spokes of a wheel of a bicycle, comprising an annular magnet-holding member and an annular support member the annular magnet-holding member comprising a plurality of magnets spaced around its circumference wherein the annular magnet-holding member is removably attached to the annular support member, so that when the annular magnet-holding member and the annular support member are attached on opposite sides of the spokes, the rotor assembly is fixed on the spokes of the wheel.

Other features and advantages of the present invention will become apparent from the following detailed description. It should be understood, however, that the specific embodiments in the detailed description are given by way of illustration only, since various changes and modifications within the spirit and scope of the invention will become apparent to those skilled in the art from this detailed description.

### BRIEF DESCRIPTION OF THE DRAWINGS

The invention will now be described, by way of example only, with reference to the following drawings, in which:

FIG. 1 is a side view of a generator for a bicycle with a rotor assembly mounted on a wheel of a bicycle, and a stator with an integrated light mounted on a front fork of the bicycle made in accordance with a preferred embodiment of the present invention;

FIG. 1a is a front view of the generator for a bicycle shown in FIG. 1 with the rotor assembly mounted on the wheel of the bicycle, and the stator with the integrated light mounted on the front fork of the bicycle;

FIG. 2 is a perspective view of the rotor assembly;

FIG. 3 is a perspective view of the generator for a bicycle shown in FIG. 1 with the rotor assembly mounted on the wheel of the bicycle, and the stator with the integrated light mounted on the front fork of the bicycle;

FIG. 4 is an exploded perspective view of the generator for a bicycle shown in FIG. 1 showing the parts of the rotor assembly, and without the stator with the integrated light;

FIG. 5 is a front view of the generator for a bicycle shown in FIG. 1 with the rotor assembly mounted on the wheel of the bicycle and without the stator with the integrated light;

FIG. 5a is a close up view of the wheel and the rotor assembly of FIG. 5;

FIG. 6 is a perspective view of the generator for a bicycle shown in FIG. 1 with the rotor assembly mounted on the wheel of the bicycle and with a centering tool and without the stator with the integrated light;

FIG. 7 is a schematic side view of a stator made in accordance with a preferred embodiment of the present invention;

FIG. 8 is a perspective view of a steel plate of a stator core of the stator shown in FIG. 7;

FIG. 9 is a side view of the stator shown in FIG. 8 with a part of a rotor assembly with two magnets;

FIG. 10 is a top view of the stator shown in FIG. 9 with a rotor assembly and magnets;

FIG. 11 is a perspective view of a stator made in accordance with an alternative embodiment of the present invention;

FIG. 12 is a side view of the stator shown in FIG. 11;

FIG. 13 is a top view of the stator shown in FIG. 11;

FIG. 14 is a perspective view of an annular stator core of the stator shown in FIG. 11;

FIG. 15 is a side cross-section view taken from line A-A of the annular stator core of FIG. 14;

FIG. 16 is a perspective view of a first annular ring with radially extending magnetically engaging members;

FIG. 17 is a perspective view of a second annular ring with radially extending magnetically engaging members; and

FIG. 18 is a schematic diagram of a generator for a bicycle.

### DETAILED DESCRIPTION OF THE PREFERRED EMBODIMENTS OF THE INVENTION

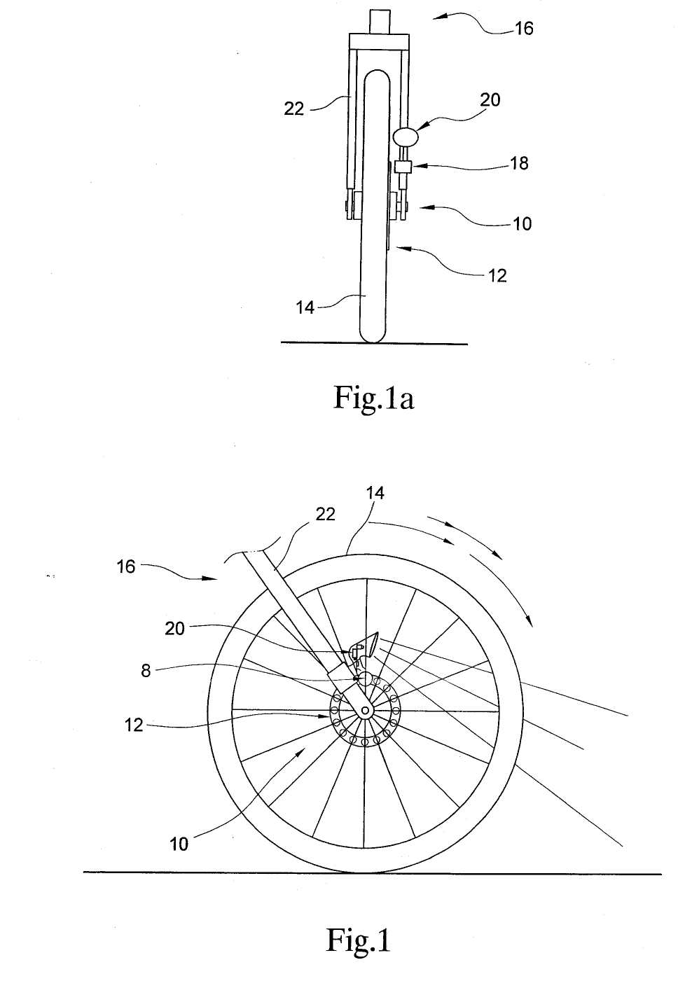

Referring now to FIGS. 1, 1a and 3, illustrated therein is a generator 10 for a bicycle 16 with a rotor assembly 12 mounted on a wheel 14 of the bicycle 16, and a stator 18 with an integrated light 20 mounted on a front fork 22 of the bicycle 16 made in accordance with a preferred embodiment of the present invention.

In other embodiments, the generator 10 may be mounted on the rear wheel of the bicycle. Also, the integrated light 20 is not a necessary part of the stator 18. In the preferred embodiment the light 20 is integrated with the stator 18 in the same container to reduce wiring and thus allowing for a more compact and durable design. However, in other embodiments the light may be mounted on other parts of the bicycle independent of the stator and connected electrically by wires. The generator 10 may provide power to other electric devices mounted on the bicycle such as rear lights, speedometers, odometers, and computers.

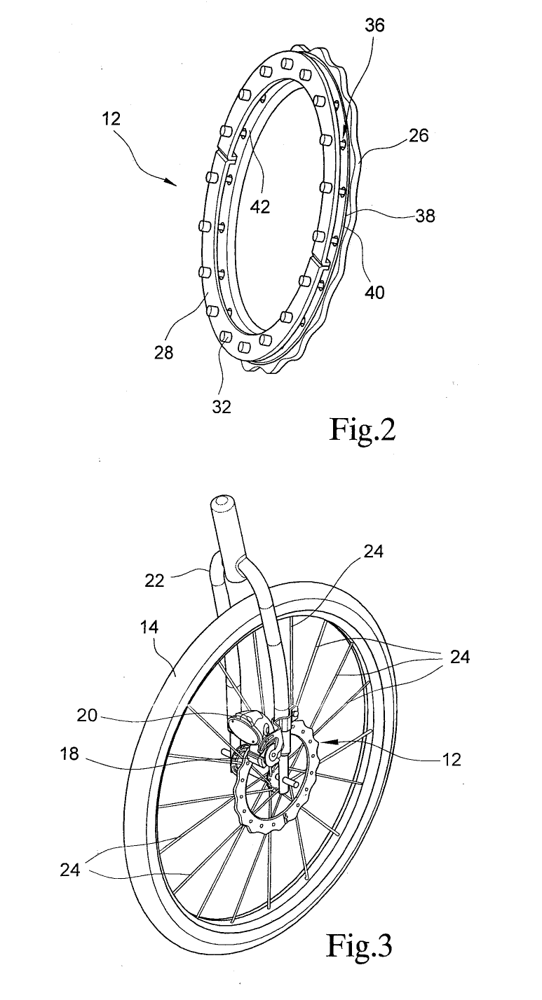

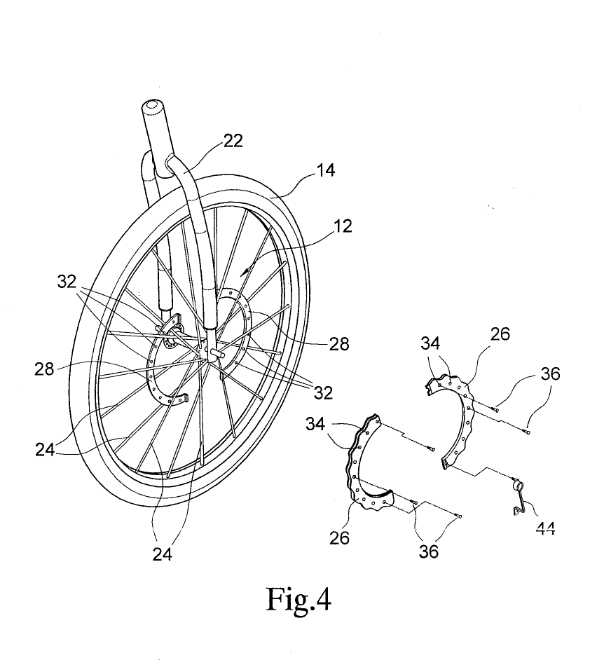

Referring now to FIG. 4, illustrated therein is an exploded perspective view of the bicycle generator 10 showing the parts of the rotor assembly 12, and without the stator 18 with the integrated light 20. The rotor assembly 12 as shown here is removably attached to the spokes 24 of the wheel 14 of the bicycle 16. As more clearly shown in FIG. 2, the rotor assembly 12 of the generator 10 comprises an annular magnet-holding member 26 and an annular support member 28. Both the magnet-holding member 26 and annular support member 28 are preferably made from plastic materials such as PVC, the use of plastics is preferable because of their durability, light weight, low cost, flexibility and non-metallic properties.

The annular magnet-holding member 26 holds a plurality of magnets spaced around its circumference (the magnets are not shown but will be discussed later). The annular magnet-holding member 26 is removably attached to the annular support member 28, such that when the annular magnet-holding member 26 and the annular support member 28 are attached on opposite sides of the spokes 24, the rotor assembly 12 is fixed on the spokes 24 of the wheel 14.

The annular magnet-holding member 26 preferably comprises a plurality of apertures 34 and the annular support member comprises a plurality of respective attachment means 32 for removably attaching the annular magnet-holding member 26 and the annular support member 28 using fastening means 36. In the preferred embodiment the fastening means 36 is a screw with an unthreaded shaft middle and a short threaded end, the length of the threaded end corresponding with the length of the respective attachment means 32 which is preferably a tapped hole. The use of the screw with the unthreaded shaft middle and short thread end prevents the user from over tightening the screw when attaching the annular magnet-holding member 26 to the annular support member 28.

Preferably the rotor assembly 12 has 18 apertures 4 on the annular magnet-holding member 26 and 18 corresponding attachment means 32 on the annual support member 28. These attachment points are evenly spaced around the circumference of the rotor assembly 12. However, the number and placement of the attachment points may vary in different embodiments of this invention.

In the preferred embodiment, the annular magnet-holding member 26 and the annular support member 28 each comprise 2 parts. The annular magnet-holding member 26 is preferably split in half with detachable snap-on attachments. This allows for easier storage and packaging. The annular support member 28 is preferably comprised of 2 parts (two half annular rings). Since the annular support member 28, when mounted on the wheel 14, goes inside of the spokes 24, it is easier to insert each half annular ring separately rather than an entire annular ring. It is not necessary for the parts of the annular support member 28 to be connected to each other as they can be separately secured to the annular magnet-holding member 26.

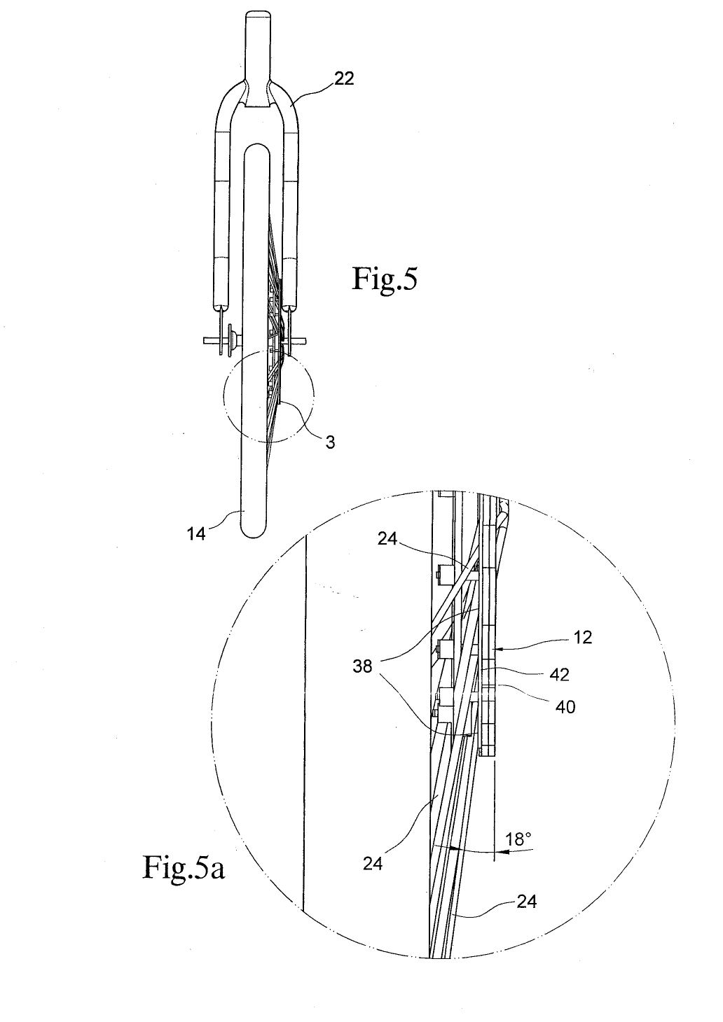

Further referring to FIGS. 2, 5 and 5a, the annular magnet-holding member 26 of the rotor assembly 12 additionally preferably comprises a spacer 38 on the radially outer portion of a spokes-facing side of the annular magnet-holding member 26 for creating a contact edge 40 with the spokes 24 of the wheel 14 such that there are two spoke contacting edges on the annular magnet-holding member 26, one being the spacer 38 and the other being the radially inner edge 42 of the annular magnet-holding member 26.

The height of the spacer 38 is preferably such that when the rotor assembly 12 is placed at the center of the wheel 14, meaning that the axis of rotation of the rotor assembly 12 is aligned with the axis of rotation of the wheel 14, the angle between the top of the spacer 38 and the radially inner edge 42 of the annular magnet-holding member 26 matches the angle of the spokes of the wheel 14 from the rim to the axis of the wheel 14. The purpose of the spacer 38 is to allow the rotor assembly 12 to be fitted at the center of the wheel 14 and prevent it from moving off center. The spokes of bicycle wheels are generally angled from the radially outer edge of the wheel to the center of the wheel, usually the hubs of the wheels are axially wider than the radially outer edge of the wheel. Thus it is desirable to have the contacting edges of the magnet-holding member 26 to match the angle of the spokes for a better fit and centering. For example, if the angle of the spokes of the wheel measured from the radially outer edge to the axial center is 18 degrees, then the height of the spacer 38 would be such that the angle measured from the spacer to the radially inner edge 42 of the annular magnet-holding member is 18 degrees.

On the stator facing side of the annular magnet-holding member 26, the surface is preferably a flat surface and parallel to the plane of rotation as can be seen in FIGS. 3 to 5. This prevents interference with the stator 18 during operation when the rotor assembly 12 rotates past the stator 18.

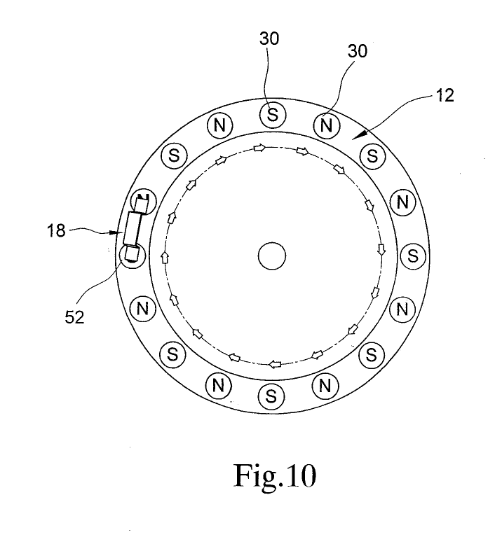

As more clearly shown in FIG. 10, the magnet-holding member 26 comprise a plurality of magnets 30 which are preferably disposed at regular circumferential spacings around the circumference of the annular magnet-holding member 26. The spacings between the magnets 30 preferably correspond to the spacing of the magnetically engaging members 52 of the stator 18. The magnets are arranged around the circumference of the annular magnet-holding member 26 with alternating polarity. Preferably, the magnets 30 are disposed within the annular magnet-holding member 26 so that the magnets 30 are not exposed. The magnets 30 may be moulded into the annular magnet-holding member 26, or alternatively, the magnets 30 may be encased in the annular magnet-holding member 26 with a 2-piece construction.

Referring now again to FIG. 4, the exploded perspective view illustrates how the rotor assembly 12 is mounted on the spokes 24 of the wheel 14. In this preferred embodiment both the annular magnet-holding member 26 and annular support member 28 comprise of 2 separate parts of half annular rings. Firstly, one part of the support member 28 is placed behind the spokes 24 of the wheel 14, then the corresponding part of the magnet-holding member 26 is placed on the opposite side sandwiching the spokes. Fasteners 34 are then inserted through apertures 34 of the magnet-holding member 26 to the attachment means 32 of the support member 28 to mount on to the spokes 24. The same procedure goes for the other half to mount on the spokes 24 and then the two halves are snapped together. In order to position the rotor assembly at the center of the wheel, a centering tool 44 is provided.

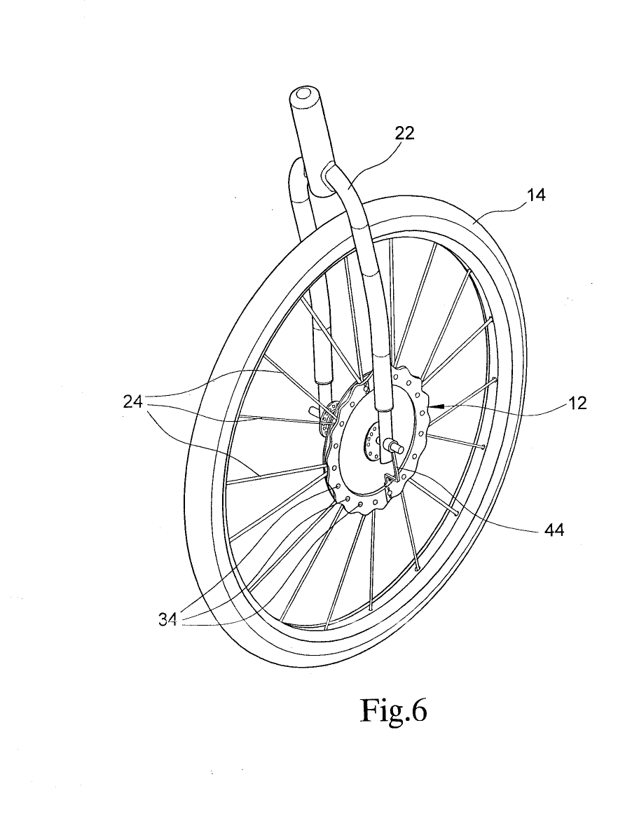

The centering tool 44 is an L-shaped rod with an aperture at the end of the rod for attaching to the axis of the wheel. As can be seen more clearly in FIG. 6, the centering tool 44 functions like a compass when the aperture end is placed on the axis of the wheel, the end of the rod provides a reference point as to where to adjust the placement of the rotor assembly 12. Once the rotor assembly 12 is positioned at the center of the wheel 14, with a common axis of rotation as the wheel 14, the fasteners 34 can be further tightened to fix the position of the rotor assembly 12 on the wheel 14.

The present invention thus provides a simple design for mounting and removing a rotor assembly for a bicycle generator. Further, this design allows the mounting of the rotor assembly without removing the wheel from the forks of the bicycle.

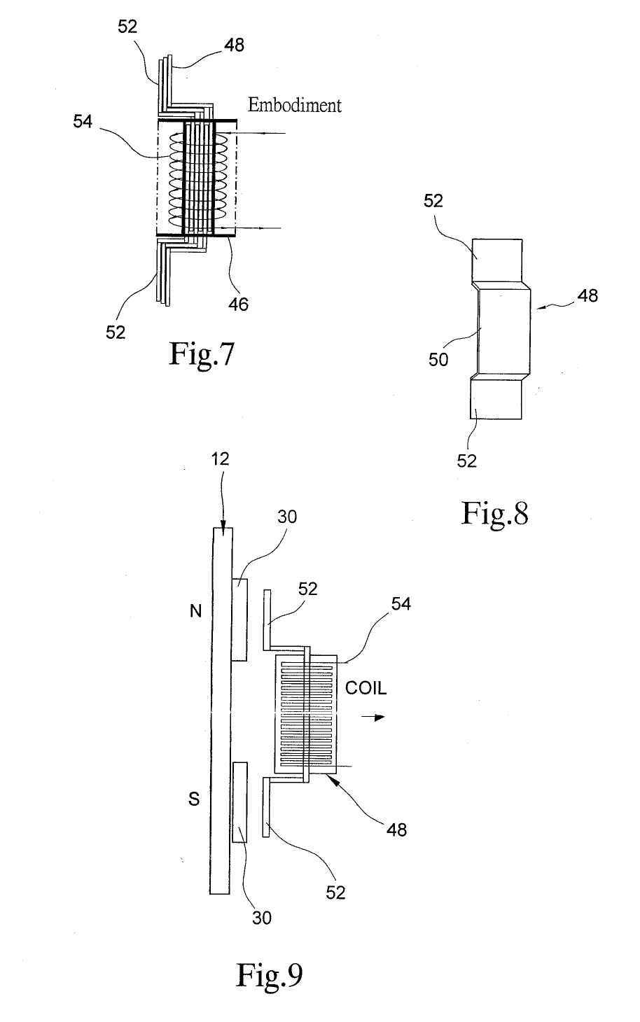

Referring now to FIG. 7, illustrated herein is a schematic side view of a stator 18 made in accordance with a preferred embodiment of the present invention. This stator 18 along with the rotor 12 described above form the major components of the preferred embodiment of the electrical generator 10 of the present invention. The stator 18 comprises a stator core 46, constructed by laminating steel plates 48. The steel plates 48 are stacked to form the stator core 46. As shown in FIG. 8, each steel plate 48 has a U-shaped grooved cross-section 50 with two oppositely extending magnetically engaging members 52. A power-generating coil 54 is wound around the U-shaped groove 50 of the steel plates 48 of the stator core 46. In different embodiments, steel plates with rectangular cross-section may be added to the stator core 46, thus the power-generating coil 54 would be wound around both the steel plates with the U-shaped grooved cross-section and the additional steel plates with rectangular cross-section to create a stator core 46 with a larger stack of steel plates making the stator core 46 more efficient.

Further referring to FIG. 9, the magnetically engaging members 52 are positioned to magnetically engage the magnets 30 of the rotor assembly 12. The word “engage” as used in this description to describe the interaction between the magnetically engaging members and the magnets means magnetically engage, such as when the magnetically engaging members cuts across the magnetic field of the magnets. Magnetic engagement does not require the physical contact of the two parts, and in this invention it is preferable that the parts do not physically come into contact so as to not cause frictional resistance. Preferably, the spacings between the magnetically engaging members 52 are substantially the same as the regular spacings of the magnets 30, as can be seen in FIGS. 9 and 10, such that when one of the magnetically engaging members 52 is engaged with a magnet 30, the other magnetically engaging member 52 is also in position to be engaged with the adjacent magnet 30 of an alternate polarity. Likewise, the spacings are such that when one of the magnetically engaging members 52 is not engaged with a magnet 30, the other magnetically engaging member is also not in a position to be engaged with a magnet 30.

The rotor assembly 12 is mounted on a on a wheel 14 of the bicycle 16 and the stator 18 is mounted on a fork 22 of the bicycle 16 such that the magnetically engaging members 52 of the stator 18 are positioned to magnetically engage the magnets 30 of the rotor assembly 12 as the rotor assembly 12 rotates.

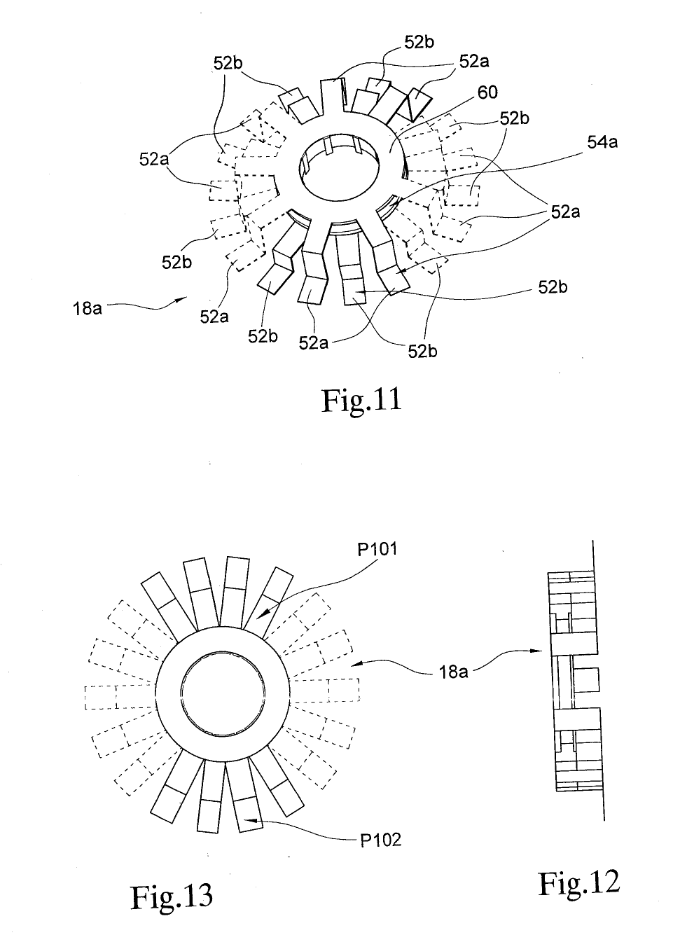

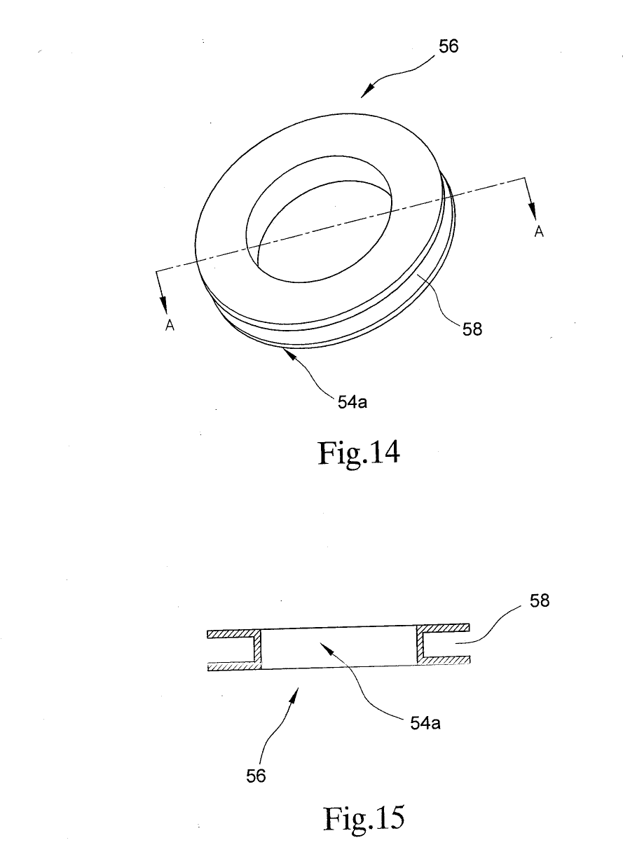

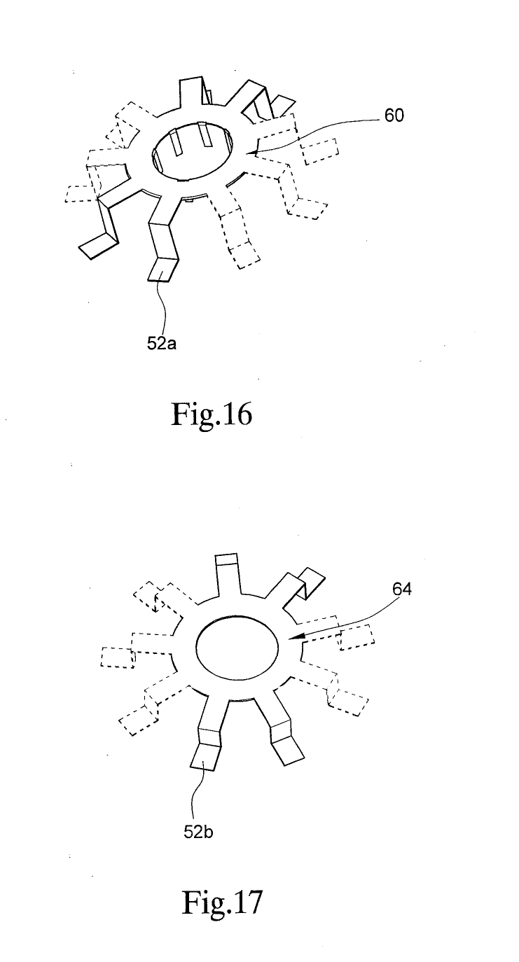

An alternative embodiment of the stator 18 of the present invention is an annular stator 18a, which is shown in FIGS. 11 to 17. The annular stator 18a comprises an annular stator core 56, shown in FIGS. 14 and 15, having a radially outer facing U-shaped annular groove 58 and having a power-generating coil 54a wound around the U-shaped groove 58. The annular stator 18a further comprises a first annular ring 60, shown in FIG. 16, disposed on a side of the annular stator core 56, with a plurality of radially extending magnetically engaging members 52a being positioned to engage the magnets 30 of the rotor assembly 12. The annular stator 18a further comprises a second annular ring 64, shown in FIG. 17, disposed on another side of the annular stator core 56, with radially extending magnetically engaging members 52b being positioned to engage the magnets 30 of the rotor assembly 12.

The magnetically engaging members 52a of the first annular ring 60 are positioned to engage magnets 30 of one polarity while the magnetically engaging members 52b of the second annular ring 64 are positioned to engage magnets 30 of an alternate polarity. In this manner each side of the annular stator core 56 is magnetically engaged with a respective polarity at one time and as the annular stator 18a rotates the polarity alternates. The spacings between the magnetically engaging members 52a and magnetically engaging members 52b are substantially the same as the regular spacings of the magnets 30 such that when one of the magnetically engaging members is magnetically engaging a respective face of the magnet 30 the rest of the magnetically engaging members are also in position to engage their respective magnets 30 of the rotor assembly 12. Likewise, the spacings are such that when one of the magnetically engaging members is not in a position to engage a magnet, the rest of the magnetically engaging members are also not in positions to do so.

In the preferred embodiment of the annular stator 18a, as shown in FIG. 11, the total number of magnetically engaging members 52a and magnetically engaging members 52b is the same as the number of magnets 30 on the rotor assembly 12. Each of the first annular ring 60 and second annular ring 64 having an equal number of magnetically engaging members.

In this alternative embodiment of the electric generator 10, the rotor assembly 12 is similarly mounted on a wheel 14 of the bicycle 16 and the annular stator 18a is mounted on a fork 22 of the bicycle 16 such that the magnetically engaging members 62 of the annular stator 18a is positioned to magnetically engage the magnets 30 of the rotor assembly 12 as the rotor assembly 12 rotates. This embodiment provides more electricity than the first embodiment described above since there are more magnetically engaging members 52a engaging the magnets 30 at the same time.

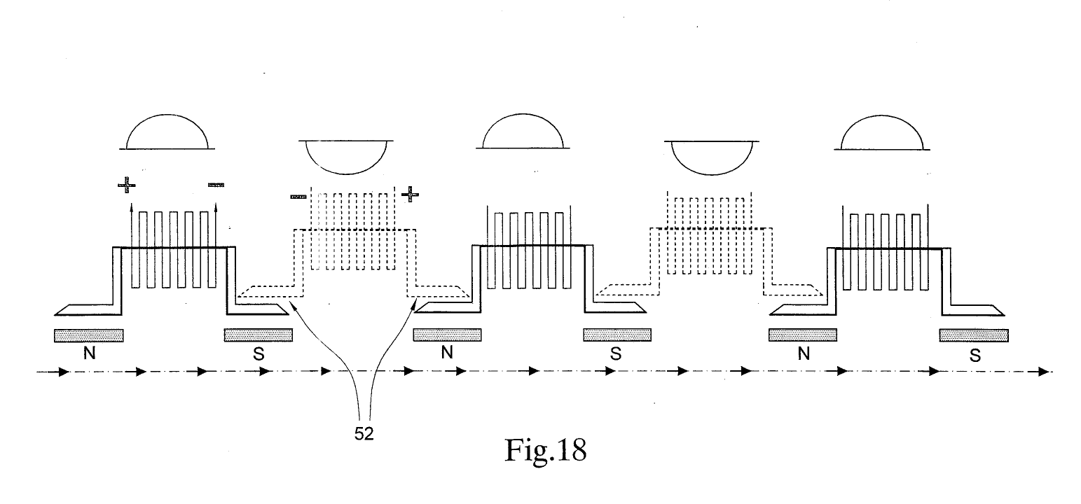

The electrical generators as described above uses electromagnetic principles to convert mechanical rotation into an alternating electric current. The magnets establish magnetic fields, and coils, which pass through the magnetic fields, produce an induced electromotive force. FIG. 18 is a schematic diagram of the electrical generator, which shows the stator at different positions as it moves from one pair of magnets to another. The top of the diagram illustrates the voltage curve generated by the electrical generator as the stator moves along the circumference of the rotor assembly.

It should therefore be apparent to one skilled in the art that various modifications can be made to the embodiments disclosed herein, without departure from the invention, the scope of which is defined in the appended claims.

1. An electric generator for a bicycle comprising:
a rotor assembly comprising a plurality of magnets disposed at regular spacings around the circumference of the rotor assembly in alternating polarity;
a stator core, comprising steel plates stacked to form the stator core;
each steel plate having a U-shaped grooved cross-section with two oppositely extending magnetically engaging members;
a power-generating coil wound around the U-shaped groove of the steel plates of the stator core; and
the magnetically engaging members being positioned to magnetically engage the magnets of the rotor assembly.

2. The electric generator as defined in claim 1, wherein the spacings between the magnetically engaging members are substantially the same as the regular spacings of the magnets so that when one of the magnetically engaging members is facing a respective face of the magnet, the other magnetically engaging member is facing the adjacent respective magnet of the rotor assembly.

3. The electric generator as defined in claim 1, wherein the stator core further comprises a plurality of steel plates with a rectangular cross-section.

4. The electric generator as defined in claim 1, wherein the rotor assembly is mounted on a wheel of the bicycle and the stator is mounted on a fork of the bicycle so that the magnetically engaging members of the stator is positioned to magnetically engage the magnets of the rotor assembly as the rotor assembly rotates.

5. An electric generator for a bicycle comprising:
a rotor assembly comprising a plurality of magnets disposed at regular spacings around the circumference of the rotor assembly in alternating polarity;
an annular stator core, having a radially outer facing U-shaped annular groove and having a power-generating coil wound around the U-shaped groove;
a first annular ring disposed on a side of the annular stator core, with a plurality of radially extending magnetically engaging members being positioned to magnetically engage the magnets of the rotor assembly; and
a second annular ring disposed on another side of the annular stator core, with radially extending magnetically engaging members being positioned to magnetically engage the magnets of the rotor assembly.

6. The electric generator as defined in claim 5, wherein the number of magnetically engaging members is the same as the number of magnets on the rotor assembly.

7. The electric generator as defined in claim 5, wherein the spacings between the magnetically engaging members are substantially the same as the regular spacings of the magnets so that when one of the magnetically engaging members is facing a respective face of the magnet, the rest of the magnetically engaging members are also facing their respective magnets on the rotor assembly.

8. The electric generator as defined in claim 5, wherein when the magnetically engaging members of the first annular ring are positioned to engage magnets of one polarity, the magnetically engaging members of the second annular ring are positioned to engage magnets of an opposite polarity.

9. The electric generator as defined in claim 5, wherein the rotor assembly is mounted on a on a wheel of the bicycle and the stator is mounted on a fork of the bicycle so that the magnetically engaging members of the stator is positioned to magnetically engage the magnets of the rotor assembly as the rotor assembly rotates.

10. A rotor assembly for a bicycle generator for mounting on to spokes of a wheel of a bicycle, comprising:
an annular magnet-holding member and an annular support member;
the annular magnet-holding member comprising a plurality of magnets spaced around its circumference;
wherein the annular magnet-holding member is removably attached to the annular support member, so that when the annular magnet-holding member and the annular support member are attached on opposite sides of the spokes, the rotor assembly is fixed on the spokes of the wheel.

11. The rotor assembly as defined in claim 9, wherein the annular magnet-holding member comprises a spacer on the radially outer portion of a spokes-facing side of the annular magnet-holding member for creating a contact edge with the spokes of the wheel so that there are two spoke contacting edges on the annular magnet-holding member, one being the spacer and the other being the radially inner edge of the annular magnet-holding member.

12. The rotor assembly as defined in claim 10, wherein the height of the spacer is so that when the rotor assembly is placed at the center of the wheel, the axis of rotation of the rotor assembly being aligned with the axis of rotation of the wheel, the angle between the top of the spacer and the radially inner edge of the annular magnet-holding member matches the angle of the spokes of the wheel from the rim to the axis of the wheel.

13. The rotor assembly as defined in claim 9, wherein the plurality of magnets are disposed at regular circumferential spacings around the circumference of the annular magnet-holding member.

14. The rotor assembly as defined in claim 12, wherein the plurality of magnets are arranged around the circumference of the annular magnet-holding member with alternating polarity.

15. The rotor assembly as defined in claim 9, wherein the annular magnet-holding member comprises a plurality of apertures and the annular support member comprises a plurality of respective attachment means for removably attaching the annular magnet-holding member and the annular support member using fastening means.

16. The rotor assembly as defined in claim 9, wherein the annular magnet-holding member comprises more than one piece wherein the pieces are detachably connected to form the annular magnet-holding member.

17. The rotor assembly as defined in claim 9, wherein the annular support member comprises more than one piece.

18. The rotor assembly as defined in claim 9, wherein the magnets are disposed within the annular magnet-holding member so that the magnets are not exposed.

19. The rotor assembly as defined in claim 9, wherein the annular magnet-holding member comprises a stator facing side with a flat surface.

20. The rotor assembly as defined in claim 9, wherein the annular magnet-holding member and the annular support member are made from plastic materials.
